(19) United States
(12) Patent Application Publication
(10) Pub. No.: US 2014/0323183 A1
(43) Pub. Date: Oct. 30, 2014

(54) Hinged Miniature Wireless Headset

(71) Applicant: Eric Albert Klein, San Francisco, CA (US)

(72) Inventor: Eric Albert Klein, San Francisco, CA (US)

(21) Appl. No.: 13/945,416

(22) Filed: Jul. 18, 2013

Related U.S. Application Data
(60) Provisional application No. 61/742,044, filed on Aug. 2, 2012.

(51) Int. Cl. H04B 1/38

(52) U.S. Cl. CPC H04B 1/385
USPC 455/569.1

(57) ABSTRACT

A hinged U-shaped battery-powered miniature wireless headset, is worn as an earring or a pair of earrings. The earset communicates with a phone or other host over a bidirectional wireless communication link allowing hands-free operation. The earset has a front and rear housings electrically and mechanically connected using a hinge, the housings containing an electronics module, a speaker assembly, a microphone assembly, an antenna, a battery, user interface devices such as a switch and LEDs, and an attachment employing either a clamp or a pierced earring post with clutch. The device is attached to the lobe of the wearer's ear. The user positions the speaker, or speaker tube, inside at the entrance to the ear canal. One microphone is mounted to point toward the user's mouth and another microphone may be positioned to receive ambient sound for signal processing to improve quality of the outgoing and/or incoming audio stream.

This application claims benefit of provisional patent application No. 61/742,044, filed Aug. 2, 2012.

### BACKGROUND OF THE INVENTION

The invention concerns digital wireless audio headsets that comprise a miniature device or pair of devices that look like and attach to the ear like earring jewelry. Miniature headsets that touch no part of the head, other than the pinna, may be referred to as earsets. Earsets form a proper subset of headsets and share the same capabilities.

Earsets may play audio such as music, be used as a wireless phone headset, or provide a voice interface to another device such as a laptop, pad computer, or smart-phone. Earsets provide a safe, hands-free way to make and receive calls when it is not convenient to hold a phone handset. Additionally, earsets allow movement of the cell phone transmitter away from the user's head, reducing the electromagnetic field strength that reaches the brain and thereby reducing potentially harmful effects.

The human pinna is sensitive, so an earset that is heavy, unbalanced, or insecure will be uncomfortable. The earset must be balanced to avoid twisting and light in weight yet carry enough battery power to deliver sufficient use time. It must be attractive enough to work as jewelry yet still fulfill its electronic functions.

An earset configured to have components both in front and behind the ear confers important advantages. A “split” configuration appears smaller and is better balanced than a unitary earset.

U.S. Pat. No. 8,086,288 to Klein (2011) entitled “Miniature Wireless Earring Headset” discloses a battery-powered miniature wireless headset is worn as a single earring or as a pair of earrings. The headset communicates with a phone or other host over a bidirectional wireless communication link allowing hands-free operation. It attaches using a clamp or a pierced earring post. This patent shows several techniques for separating the device into front and back sections, but does not describe any hinged or U-shaped configurations.

Accordingly, several advantages of one or more aspects of the invention are:

(a) to provide a miniaturized wireless earset that appears smaller than its actual size;

(b) to provide a wireless earset that is well balanced and does not twist;

(c) to provide a wireless earset which is practical to manufacture;

(d) to provide a wireless earset which may be easily adjusted to fit a variety of pinna shapes;

(e) to provide a wireless earset which need not be removed to interact with the outside world;

(f) to provide a miniature wireless earset with power system designs that are small in size and weight yet have sufficient power capacity for practical duration of use;

(g) to provide a miniature wireless earset with antenna configurations that provide adequate signal propagation yet are compatible with the severe size and weight constraints imposed by the form factor;

(h) to provide a miniature wireless earset that is well suited to provide ubiquitous audio;

(i) to provide a miniature wireless earset that is well suited to provide audio augmented reality;

(j) to provide a miniature wireless earset that is well suited to provide audio location based information to the user.

### SUMMARY OF THE INVENTION

A hinged U-shaped battery-powered miniature wireless headset, or earset, is worn as a single earring or as a pair of earrings. The earset wirelessly communicates a host phone or other communicating device, allowing hands-free operation. The earset may consist of a single device worn on one ear or a pair of devices worn on both ears. Each device consists of an electronics module, a speaker assembly, one or more microphones, an antenna, a battery, user interface devices such as switches and LEDs, and a mechanism of attachment to the pinna utilizing a clamp or piercing post. The components are fitted into a single U-shaped case or a pair of electrically connected cases that form a U-shape and are configured to hinge open to increase the width of the opening to facilitate earset installation or removal, and hinge closed to secure the device while in use.

In one aspect the device is attached to the wearer's pinna(s) by inserting a post through an earlobe piercing and securing it with a clutch or nut.

In another aspect the device is attached to the wearer's pinna(s) by means of a spring clamp or screw clamp that squeezes the earlobe.

The user may position the speaker assembly inside of, or at the entrance to, the ear canal. The speaker assembly is held in the canal by friction and is connected to the body of the device using a short rigid, semi-rigid, or flexible boom. The distance and angle between the speaker and the post are adjustable to compensate for different pinna sizes, shapes, and piercing locations. The device can be offered in a single size with an adjustable speaker boom, in a variety of sizes with adjustable speaker boom, or a variety of sizes with non-adjustable speaker boom.

A microphone is mounted in such a way that it points towards the user's mouth. The microphone input is used for three different purposes, depending upon the current state of the device. In the first case, where the device is being used as a phone earset, the user's words are received by the microphone, processed, and transmitted to the host phone via the wireless link. In the second case, where the user is interacting with the immediate environment, the microphone input is routed to the earset speaker. In the third case, where the user wishes to mute environmental sound, the microphone input is used to generate anti-noise for active noise control. Note that audio streams may be mixed so that the user is listening to a voice or audio stream mixed with the anti-noise or environmental sound stream. A second microphone may be used to detect ambient sound as input to a signal processor to improve the quality of incoming and outgoing audio data streams.

The same hardware and electronics may be used for an audio player, phone earset, or combined unit. The only differences are in the earset firmware and the wireless data packets.

The earset may be powered by a compact power source, most commonly a primary or secondary (rechargeable) battery. The battery has enough capacity to power the earset for at least two hours of telephone conversation and at least eight hours of standby operation. The device may be powered on either before or after attaching it to the pinna.

The preferred embodiment uses the BLUETOOTH (trademark of Bluetooth SIG, Inc.) wireless protocol to communicate between earset and host. Bluetooth is a specification for short-distance bidirectional wireless communication between two devices.

The earring earset may be formed in any number of plain or decorative designs. Miniature components allow the device to be small enough to be worn comfortably for long periods. These and other objects, advantages and features of the invention will be apparent from the following description of a preferred embodiment, considered along with the accompanying drawings.

### DESCRIPTION OF THE DRAWINGS

FIGS. 1-6 illustrate a right-ear version of an earset. For convenience of description, the decorated earring face will be called the “front” and all other faces will derive their direction from this front face. In these figures:

FIG. 1a is a perspective view of a right front of a hinged pierced embodiment of the earset in closed position.

FIG. 1b is a perspective view of a left front of a hinged pierced embodiment of the earset in open position.

FIG. 1c is a disassembled perspective view of a left front of a hinged embodiment of the earset.

FIG. 1d is a front view of a flattened flexible PCB of the earset.

FIG. 2a is a right perspective view of a hinged clamp embodiment of the earset in closed position.

FIG. 2b is a left perspective view of a hinged clamp embodiment of the earset in open position.

FIG. 3a is a perspective view of a right front of a hinged embodiment of the earset that uses a sound tube to carry audio to the user's ear.

FIG. 3b is a perspective view of FIG. 3a showing the speaker and sound tube.

FIG. 4 is a right front perspective view of a unitary embodiment of the earset that uses a sound tube to carry audio to the user's ear.

FIG. 5a is a right front perspective view of a hinged embodiment of the earset that uses a rear sound tube.

FIG. 5b is a left front perspective view of the FIG. 5a embodiment.

FIG. 6a is a right front perspective view of a hinged embodiment of the earset that uses an array of tri-color LEDs on the front face.

FIG. 6b is a partially disassembled view of FIG. 6a.

### DESCRIPTION OF PREFERRED EMBODIMENTS

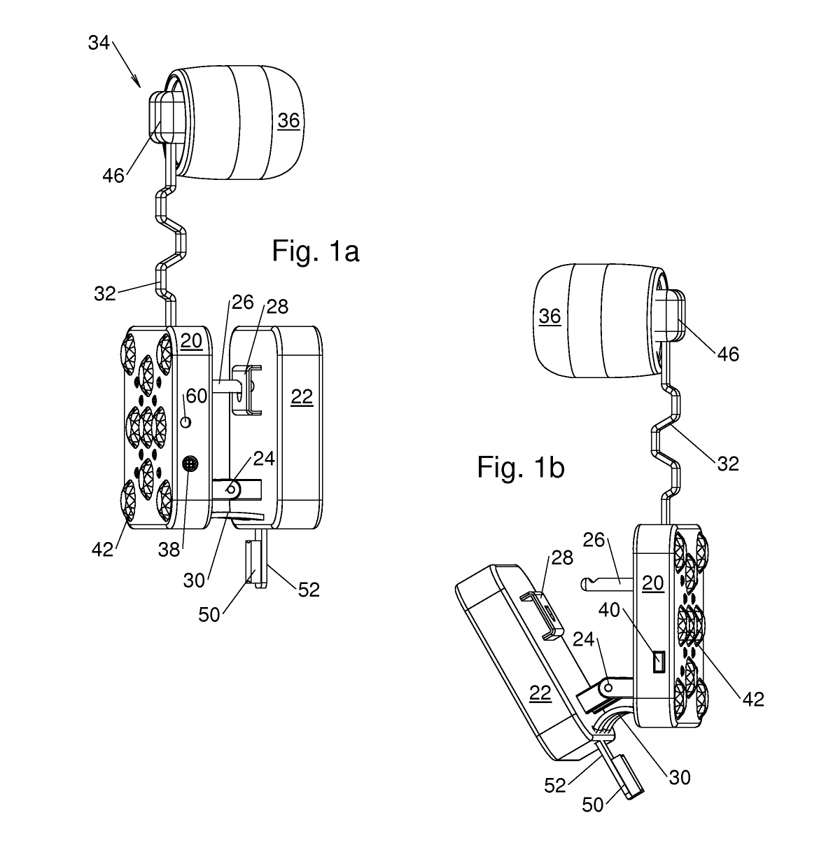

FIG. 1a is a perspective view of a right front of a hinged embodiment of an earset in closed position. The illustrated earset is designed to be worn on the right ear. A speaker assembly 34 comprises a speaker enclosure 46 and a soft flexible earbud 36. A speaker boom or cord 32 connects assembly 34 to a front electronics case 20 decorated with a pattern 42. A microphone 38 points toward the user's mouth to receive speech through a hole in the case. A light emitting diode or LED 60 indicates device state. A hinge 24 and an electrical connector 30 permanently connects front case 20 to a rear case 22. A piercing post 26 on case 20 removably connects with an earring post catch 28 on rear case 22. Depending from the bottom of rear case 22 is an antenna mount 52 and a chip antenna 50. Antenna 50, mounted to extend outside the cover, receives radio frequency radiation without being blocked by a metallic cover. Chip antennas are typically quarter wave antennas and require an RF ground plane to function effectively. A metal case may function as the RF ground plane. If the case is non-metallic, an RF ground plane may be formed on the PCB. The antenna resonant frequency may need to be tuned for best performance. This can be achieved by means of a three-element network, placed at the input to the antenna. Typically a capacitor pair and an inductor, or an inductor pair and a capacitor, will provide sufficient tuning capability.

FIG. 1b is a perspective view of a left front of a hinged embodiment of the earset in open position. The notched piercing post 26 is disassembled from post catch 28. A combined switch 40 is visible.

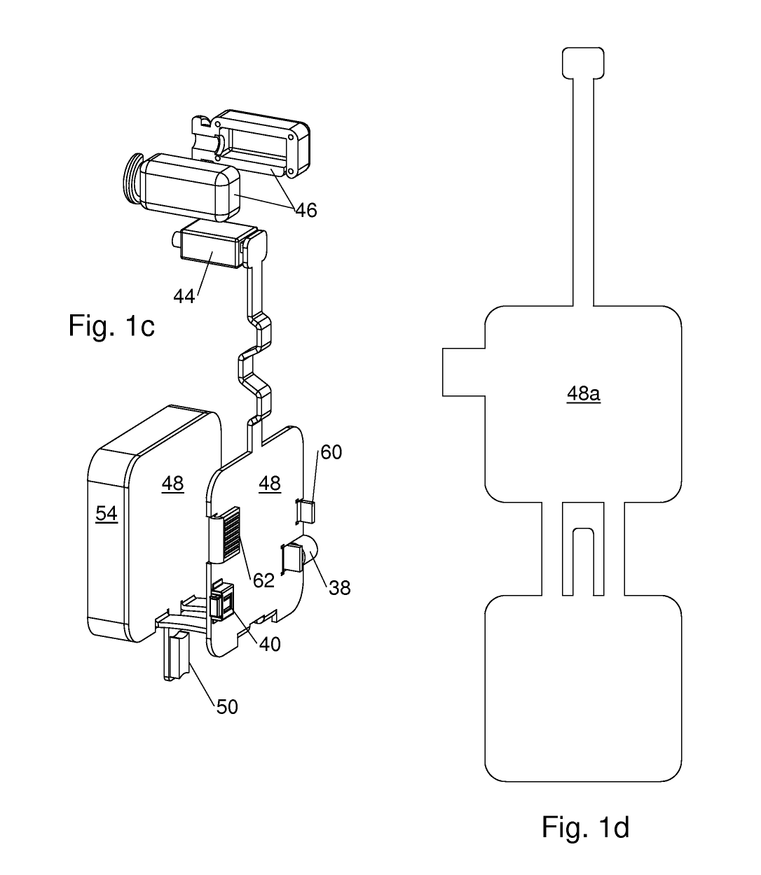

In the embodiment illustrated in FIGS. 1a and 1b, notched earring post 26 engages post catch 28 to hold the front and rear cases in an adjacent position. An alternate embodiment that omits post catch 28 uses a spring connected to the front and rear case to hold the cases in adjacent positions as illustrated in FIGS. 2a and 2b.

To install, the user opens the earset into the position shown in FIG. 1b, pushes post 20 through a piercing in the earlobe, then closes the earset. The post bends down somewhat as it's pushed through the post catch and a ridge on the catch engages the post notch thus securing the device. The earset may be powered on either before or after attaching it to the ear. The user positions the speaker assembly inside of, or at the entrance to, the ear canal. The speaker position may be adjusted by bending the speaker boom 32. The speaker position in the ear canal stabilizes the earset and supports some of the weight. The microphone assembly is mounted in such a way that it points towards the user's mouth and may be positioned on a boom to move it closer to the mouth. It need not be directly at the mouth, and may be closer to the ear than to the mouth.

Combination switch 40 controls power, volume, call pickup, and hangup. The switch may be moved in three directions: up and down as in a toggle switch and back as in a pushbutton. Toggling the switch up increases speaker volume while toggling down reduces volume. Pressing backward signals the device to accept or hang up a call, depending upon whether a call is currently in progress. Pressing the switch backward and holding for a period of several seconds powers the device on or off. Alternatively, pickup, hangup, and volume may be controlled by the external host communicating commands over the wireless link.

FIG. 1c is a partially disassembled perspective view of a left front of the earset. The two sides of the speaker enclosure 46 enclose a speaker 44. The speaker illustrated is a sub-miniature balanced armature sound transducer. A flexible printed circuit board or PCB 48 is bent into a U-shape and forms the speaker boom 32, the electrical front case/rear case connector, and the antenna mount. The speaker boom 32 is folded to form a pleated, accordion-like structure. The pleated structure allows the boom to effectively vary in length and to bend laterally to accommodate different ear shapes and sizes. The boom may be completely flexible, or may be semi-rigid and “remember” its configuration through use of an integrated bendable wire or similar means.

Microphone 30, switch 40, battery 54, and antenna 50 all interconnect through traces on the PCB. An I/O connector 62 is used to program and test the device. ICs that provide Bluetooth functionality (RF, Bluetooth stack, memory, and passives such as resistors and capacitors) also are mounted on the PCB, but are not shown as the details vary between implementations.

Flexible PCBs, also called flex PCBs, can be lighter and thinner than traditional PCBs. Flex PCB designs can eliminate connectors, cables, and solder joints to reduce cost and improve reliability. Most of the electronic components in a typical Bluetooth circuit design are resistors and capacitors which can be integrated into the PCB using embedded passive components. Embedded passive (EP) components are electronic components, such as capacitors and resistors, that are placed directly on inner layers of a PCB to replace traditional discrete components. EP components reduce size and weight of complex boards. Because of freed up board real estate (e.g. fewer components and solder joints on outer layer) there is more space for additional silicon and greater design flexibility. Signal integrity is improved, especially in the RF region. Embedded passive components may be tuned using a technique called trimming. Trimming removes material from a targeted component to achieve a predetermined physical property (e.g. resistivity). Laser trimming is a fast economical trimming method.

FIG. 1d shows a flexible PCB 48a as it looks flattened out before being folded and bent.

FIG. 2a is a right perspective view of a hinged clamp embodiment of the earset in closed position. A coiled speaker cord 32a connects assembly 34 to front electronics case 20. Microphone 38 points towards the user's mouth to receive speech through a hole in the case. Hinge 24 an electrical connector 30 permanently connects front case 20 to rear case 22. A set of clamp pads 31 on front case 20 and rear case 22 are positioned to grasp the wearer's earlobe. A set of springs 33, connected to the front and rear case, act to force the clamp pads closer together to apply clamping pressure to the user's earlobe. The pads may be formed of a soft material to increase comfort or alternatively may comprise merely bulges formed from the case material. Rear case 22 houses the battery.

FIG. 2b is a left perspective view of a hinged clamp embodiment of the earset in open position. In the open position the clamp pads 31 are further apart and do not engage the user's earlobe. The user spreads the earset into the open position to don or remove the earset.

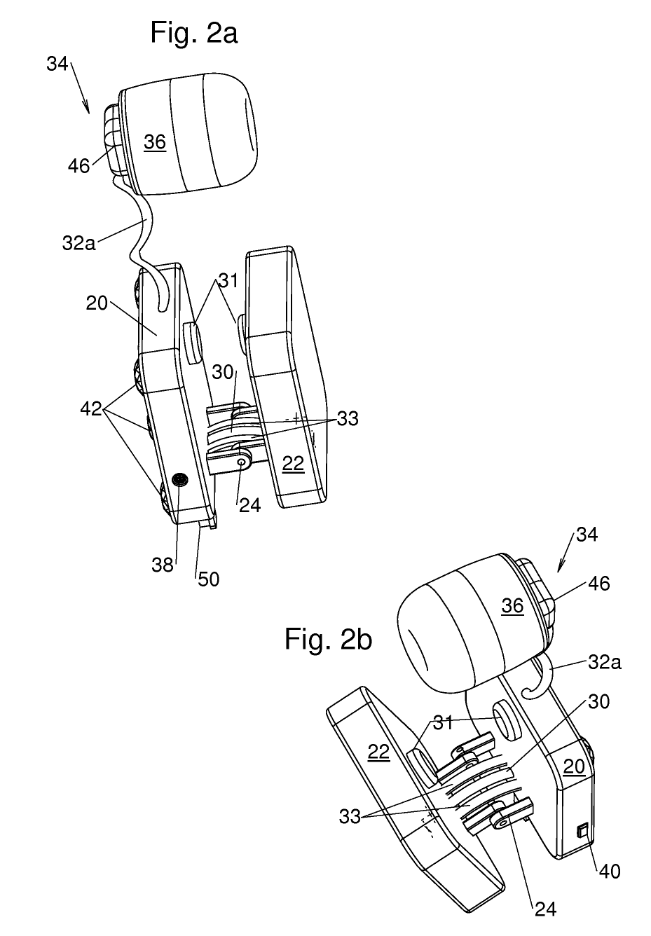

FIG. 3a is a right front perspective view of an alternate embodiment of the hinged earset that uses a sound tube 56 to carry audio to an earbud 36a to be inserted into the user's ear. A pair of charging ports 64 provides electrical power for charging the battery.

FIG. 3b is a perspective view of a part of FIG. 3a showing the speaker 44, sound tube 56, and earbud 36a.

Having the speaker housed in the case provides a possibly more durable implementation since the voice tube and earbud can easily and cheaply be replaced if damaged or worn.

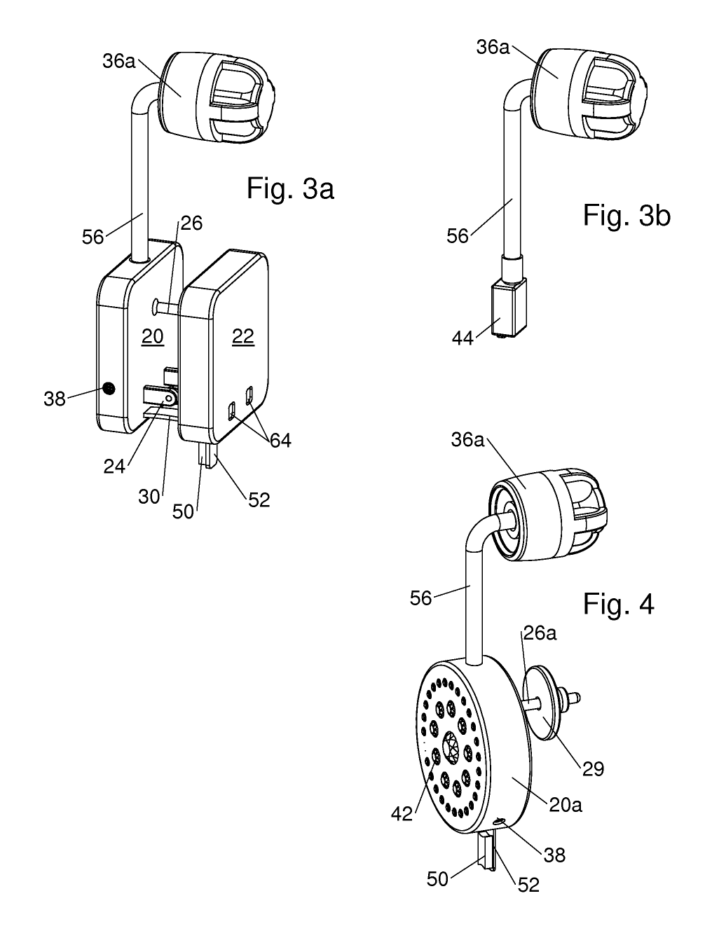

FIG. 4 is a right front perspective view of a unitary embodiment of the earset that uses a sound tube to carry audio to the user's ear. A unitary case 20a contains the earset printed circuit board, battery, microphone, and speaker. An un-notched piercing post 26a extends through a removable piercing clutch 29. A clamp could be provided in lieu of the pierce post. The sound tube in FIGS. 3a-4 can be of adjustable length.

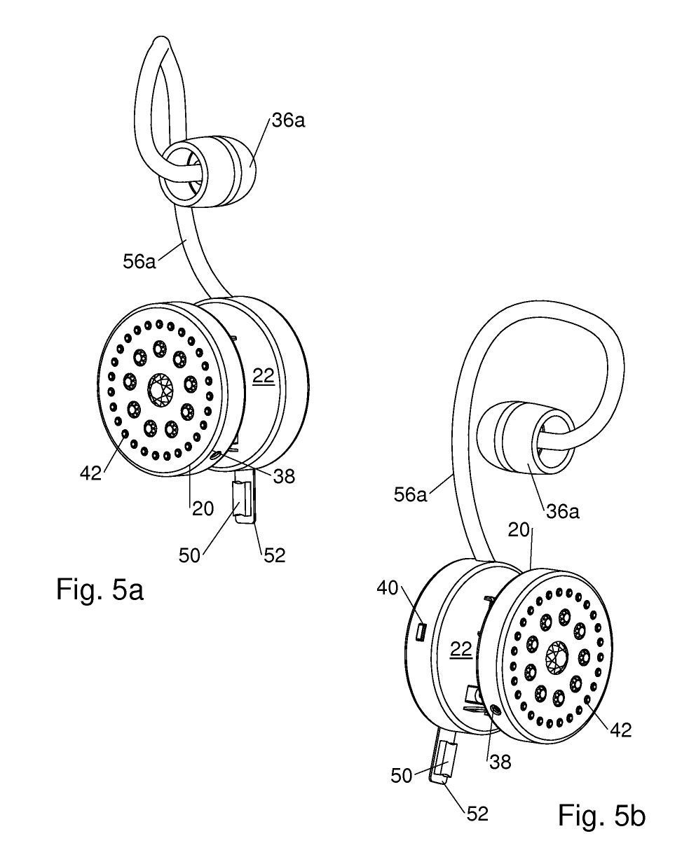

FIG. 5a is a right front perspective view of a hinged embodiment of the earset that uses a rear sound tube 56a. Tube 56a extends upward from rear case 22 and passes behind the ear and over the top of the ear to the front where it terminates in earbud 36a positioned for insertion into the ear canal. Note that this configuration requires that the speaker (not shown) be housed in the rear housing. Microphone 38 points towards the user's mouth.

FIG. 5b is a left front perspective view of the FIG. 5a embodiment. Switch 40 is mounted on the rear housing as an alternative to mounting it on the front housing. Second microphone 38 is visible on front housing 20. This microphone points away from the user's mouth and is used for purposes of audio processing to determine ambient sound to isolate the user's voice and for noise suppression. Any of the embodiments may use two microphones.

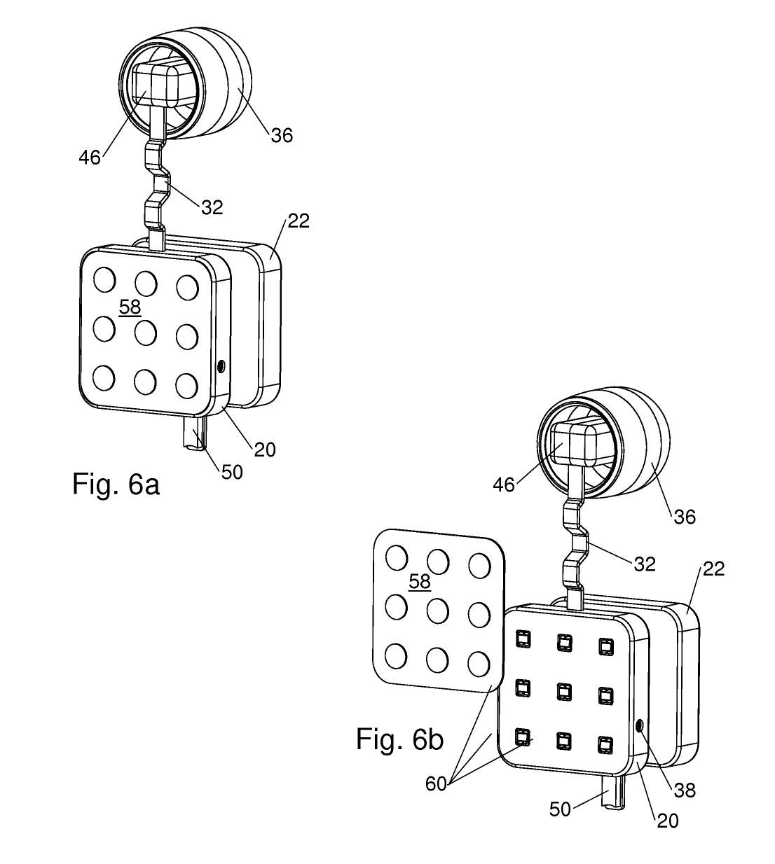

FIG. 6a is a right front perspective view of a hinged embodiment of the earset that uses a diffuser lens 58 mounted on the front face. FIG. 6b is a partially disassembled view of FIG. 6a showing the diffuser and an array of tri-color LEDs 60. The LEDs may be varied in intensity using pulse width modulation and may be varied in perceived color by adjusting the intensity of each of the red, green, and blue components. Other variable light emitting technologies, such as electroluminiscent dots, may be employed.

The array of LEDs may be used to signal the user's state or for decorative purposes.

Using the LEDs to signal the user's state allows others to understand when the user is engaged. The following signals define an easy to understand signaling system.

No lights on: audio is completely off, but ringer may be on.

Lights green: user available for interaction, but the user:
1. Might be listening to audio such as music or other low priority audio.
2. In a paused conversation with a remote party.

Lights yellow: user trying to do 2 things at once.
1. On the phone but still able to interact.
2. Working but still open to interruption.

Lights red: user does not want to be disturbed.

When used decoratively the LEDs may remain fixed in a RGB color at a fixed intensity, change color, blink, or otherwise vary intensity. The LEDs may vary individually or collectively in patterns.

The LEDs may be under the direct control of the user using a host application, follow a protocol for signaling where the signal directly relates to the user activity, or follow a host programmed sequence.

A typical use would be to vary the perceived color of the earset to, for example, coordinate with the user's clothing colors.

The earset communicates with a conventional or wireless telephone using a bidirectional wireless communication link. When powered on the earset is in standby mode, monitoring the wireless link, waiting for a call. When a call is received by the user's phone, the phone sends a ring signal to the earset, which generates an audible ring tone at the speaker. The user presses a switch, either on the phone or earset, to accept the call. The user's words are picked up by the earset microphone, converted from analog to digital, optionally processed to enhance voice clarity and reduce noise, processed in accordance with the link protocol, then transmitted to the phone via the wireless link. The other party's words are received by the phone and transmitted to the earset using the same wireless link. The earset receives the data, processes it in accordance with the link protocol, extracts the audio, performs a conversion from digital to analog, and sends the analog signal to the speaker. The user may terminate the call using a switch on the earset or phone, or the call may be terminated by the other party.

The currently preferred embodiment uses the Bluetooth wireless protocol to communicate between headset and phone. Bluetooth is a specification for short-distance wireless communication between two devices. Bluetooth devices operate at a radio frequency of approximately 2.4 GHz and have a typical maximum range of 10 meters at 2.5 mW maximum output power, though higher and lower power class devices have longer and shorter ranges respectively. The Bluetooth communication channel can support both data (asynchronous) and voice (synchronous) communications with a total bandwidth of 1 Mb/sec. Asynchronous mode is typically used for listening to music and other recorded audio. The audio can be buffered in the headset for greater fidelity, with the tradeoff that the audio is delayed. Voice data in a telephone conversation is synchronous (i.e., not buffered) since buffering the data causes perceptible delays that interfere with smooth conversation. The Bluetooth Special Interest Group (SIG) has published a headset specification (Section K6 in the Bluetooth profiles specification, v1.1) which defines a standard protocol for communicating between a phone and headset. RF circuit design is beyond the scope of this document but is well known to those knowledgeable in the art.

There are many Bluetooth headsets currently on the market and the technology is available off-the-shelf. For example, CSR of Cambridge, United Kingdom, offers a line of Bluetooth chips and related specifications, sold under the trademark BlueCore, that can be used to implement a Bluetooth headset. BlueCore 3-Multimedia combines radio frequency, baseband (digital processing), audio codec, power supply, and antenna balancing onto a single chip. BlueCore technology specifies a radio frequency schematic and printed board schematic that define the radio transceiver, reduced instruction set computer (RISC) processor module, necessary RAM, PROM or EPROM, and software. The next generation CSR chip, sold under the trademark BlueCore 4, is available in sample quantities. It requires less power and has higher bandwidth than previous models.

The Bluecore software implements an RF controller, Bluetooth software stack, headset library, and headset application. It handles user interface devices including buttons and LEDs, power management, microphone muting, speaker volume adjustment, and other functions. Other software functions include Digital Signal Processing (DSP) that sharpens the call at both ends. DSP functions include “active noise cancellation”, automatic speaker volume control depending on ambient sound levels, automatic analysis of incoming signal to raise the volume of softer sections over the noise floor, and subtraction of ambient noise from the output audio.

User interface devices consist of switches and LEDs. The Bluetooth headset profile specifies four switches: power, volume up, volume down, and talk. The power and volume switches are self explanatory. The talk switch is activated when the user desires to answer a call. The LEDs indicate device states such as power status, call status, etc.

The small size of the earset makes switches hard to place and to operate. A single switch may operate as a combined power on/off (to turn off, press switch and hold) and call pickup and hangup (brief switch press). It is even possible to build an earset that has no mechanical switches. In this case, all control signals are commanded by the host.

Host commands include on/off/standby, volume up/down, accept/reject call.

The power supply system is operated from a lithium-ion or lithium-polymer battery that provides a nominal voltage of 3.6V. The battery may be of a known type used in compact electronic devices. For example, a suitable lithium-ion Battery model GSP 051219 is produced by Great Power Battery Co., Ltd. of Guangdong Province, China. This battery provides a nominal 3.7 volt output, has a capacity of 70 mAh, weighs 1.8 grams, and is 19 mm long, 12 mm wide, and 5 mm thick. A slightly larger battery from the same manufacturer, model GSP 351624, provides a nominal 3.7 volt output, has a capacity of 100 mAh, weighs 2.3 grams, and is 24 mm long, 16 mm wide, and 3.5 mm thick. A voltage regulator, integrated into the BlueCore chip, supplies 3.0V to supply the flash memory (if used) and the codec. A separate on-chip regulator supplies 1.8 V. Most of the device is powered by the 1.8 V, including the radio and microprocessor.

An inexpensive printed antenna may be used. At 2.4 GHz a quarter wavelength antenna has a length of approximately 32 mm. Good results can be achieved with a simple flying-wire antenna or planar-inverted ‘F’ antenna (PIFA). Fractal antennas can operate efficiently at one-quarter the size of more traditional designs. More sophisticated antenna configurations may reduce radiated power levels while maintaining radio range. The antenna may be of a known type designed for compact devices. For example, Fractus Micro Reach Xtend model antenna, available from Fractus Antennas located in Barcelona, Spain, is designed for 2.4 GHz operation, is PCB mountable, and is compact, measuring 3.7 mm long, 2 mm wide, and 1 mm thick.

The audio module is comprised of an on-chip audio codec, a microphone, and a speaker. The codec digitizes analog data from the microphone and performs band limiting and smoothing as required for voice coding. The codec accepts audio data and reconstructs it using a digital-to-analog converter for output to the speaker.

Miniature microphones and speakers are available that combine low power consumption with small size and weight. For example, Sonion in Denmark offers a miniature omni-directional microphone, Model 8000. This microphone is 2.6 mm in diameter and 2.6 mm in height. Sub-miniature balanced armature speakers are available from a variety of suppliers. For example, the Knowles division of Dover Corporation, based in Itasca, Ill., offers a line of sub-miniature balanced armature speakers that are used for hearing aids and other audio applications.

Alternative Wireless Technologies

Alternative embodiments may use other wireless protocols and carriers for communication between the headset and host. These include IEEE 802.11 which uses RF, magnetic induction communications, and IrDA which uses the infrared band.

IEEE 802.11 refers to a family of specifications developed by the Institute of Electrical and Electronics Engineers for wireless local area network (LAN) technology. 802.11 specifies an over-the-air interface between a wireless client and a base station or between two wireless clients. 802.11 operates in the same 2.4 GHz band as does Bluetooth, though using frequency hopping techniques the two can coexist in the same area. 802.11 is typically longer range and higher power than Bluetooth.

Magnetic induction communication (sometimes called near-field magnetic communications) is being used now in a mobile phone headset sold by Michigan-based foneGEAR Inc. FoneGEAR is using the technology developed by Aura Communications Inc. of Wilmington, Mass. Aura's magnetic induction communications technology, which it sells under the trademark LibertyLink, operates in the 13.5 MHZ spectrum for headsets and transmits digital signals over a range limited to about six feet. Aura's technology sends signals between two devices by coupling a low-power, non-propagating, quasi-static magnetic field. The technology reportedly requires less power and requires fewer components than Bluetooth. Data rates can range from 64 kilobits per second for voice to 204.8 kbps for data.

The Infrared Data Association (IrDA) has specified the physical and protocol layers necessary for any two devices that conform to the IrDA standards to detect each other and exchange data. The devices must have an unobstructed line of sight. The initial IrDA 1.0 specification detailed a serial, half-duplex, asynchronous system with transfer rates of 2400 bits/s to 115,200 bits/s at a range of up to one meter with a viewing half-angle of between 15 and 30 degrees. IrDA has extended the physical layer specification to allow data communications at transfer rates up to 4 Mbits/s.

Two-Earring Embodiment

This application primarily describes the earset as being worn on a single pinna, but a pair of earring earsets may also be used. The advantages of using two earrings include clearer sound, stereo sound, and clearer voice pickup. Tradeoffs compared to one earring include higher cost and a requirement to wear two devices. The wireless protocol can be configured with the host recognizing the presence of two earsets, or the two earsets can be configured to appear as a single device to the host. The earsets can define their own sub-net, with one of the earsets acting as sub-net master and communicating with the other earset and the host. With two microphones aligned in an array, a straightforward algorithm predicated upon a time-delay principle can be configured to filter the audio input by attenuating sound which is not received by both microphones within a range of simultaneity. Acoustic waves outside the range are attenuated. Knowles Acoustics has developed an algorithm that predicates itself upon a time-delay principle to configure an array processor with a predetermined Look Angle and Angle of Acceptance onto the speech source. All acoustic plane waves outside the angle of acceptance are attenuated by greater than 15 dB for a two-element array.

Audio Processing Modes

The microphone input may be used for three different purposes, depending upon the current state of the device. In the first case, where the device is being used as a phone earset, the user's words are received by the microphone, processed, and transmitted to the host phone via the wireless link. In the second case, where the user is interacting with the immediate environment, the microphone input is routed to the earset speaker. In the third case, where the user wishes to mute environmental sound, the microphone input is used to generate anti-noise for active noise control. Note that audio streams may be mixed so that the user is listening to a voice or audio stream mixed with the anti-noise or environmental sound stream.

Digital Signal Processing (DSP) may be used to sharpen the call at both ends. DSP functions include “active noise cancellation”, automatic speaker volume control depending on ambient sound levels, automatic analysis of incoming signal to raise the volume of softer sections over the noise floor, and subtraction of ambient noise from the output audio.

The wireless earring earset of various embodiments provides a small, lightweight headset that attaches securely yet comfortably to the user's ear pinna and can be easily adjusted to fit a variety of pinna shapes. It is quick and easy to attach and detach and may be worn comfortably for long periods. The earset may be shaped and decorated as jewelry that combines beauty with utility. It can interface with a cell phone, a wired phone, a digital audio player, or a computer and act as a bidirectional phone headset, an audio headset, or a voice interface to a computing device. It can be configured to act as either an open design, allowing outside sound to be heard, or as a closed design, excluding outside sound, under electronic control of the user. When configured as an open design, or when not in use, it need not be removed to interact with the outside world.

Although the description above contains many specifities, these should not be construed as limiting the scope of the invention but as merely providing illustrations of some of the presently preferred embodiments of the invention.

For example, rather than canal speakers that are seated in the ear canal or earbuds which are worn pointing toward the ear canal, the speakers may be earbuds which are vertically mounted and worn sideways.

The electronics module and cover may be formed in shapes other than the illustrated rectangular and circular shapes. Speaker assemblies are shown with radially symmetrical housings, but the speaker housing can be non-symmetrical for better match with pinna contours.

Although the earset power source is described as a battery, other power sources may be used. These include fuel cells and ultra-capacitors such as electrochemical double-layer capacitors or nanogate capacitors.

The earset may incorporate advanced headset features. Voice dialing is a feature that uses voice recognition to initiate calls. DSP features may be used to enhance voice quality.

The earset may omit user interface switches and LEDs. The earset may power on when assembled, while call pickup/hangup and audio volume may be controlled by the host phone or computer.

The earset is shown with front and rear housings connected with a hinge. Instead, the housings may be connected by a bendable spar that allows the two parts to flex away from each other by exerting force to bend the spar. The spar acts as, and is equivalent to, a spring loaded hinge. Another alternative would involve the use of a telescoping spar or other contrivance that adjusts its length without using any hinge mechanism.

The above described preferred embodiments are intended to illustrate the principles of the invention, but not to limit its scope. Other embodiments and variations to this preferred embodiment will be apparent to those skilled in the art and may be made without departing from the spirit and scope of the invention as defined in the following claims and their legal equivalents.

I claim:

1. A wireless audio headset for action to and suspension from a human ear, comprising:
a speaker for engagement with the pinna of the ear,
a two-part housing including a front case and a rear case connected by a hinge so as to swing toward and away from one another, one of the cases having an ear pierce post extending generally toward the other case, and the other case having a post catch for latching together with the ear pierce post, to hold the two cases in an adjacent position,
an adjustable speaker boom connecting the speaker with the housing, and the housing including electronics connected by conductors to the speaker along the boom,
the housing further including a transceiver, an antenna, and a microphone connected to the electronics, the microphone being oriented toward a user's mouth when the headset is worn,
the ear pierce post being positioned to be at the lobe of a user's ear, so that the ear pierce post secures the housing to the ear lobe when the pierce post extends through a piercing in the ear lobe and engages with the catch with the two cases being positioned on opposite sides of the ear lobe.

2. The headset of claim 1, wherein the housing includes a battery wired to the electronics, with the battery and electronics being contained in different ones of the two cases.

3. The headset of claim 1, wherein the pierce post is secured to the front case and a catch is secured to the rear case.

4. The headset of claim 1, wherein the speaker boom comprises a bendable electrical cord with the conductors connecting the speaker to the electronics.

5. The headset of claim 1, wherein the electronics are contained in the housing case from which the boom extends.

6. The headset of claim 1, wherein the hinge comprises a bendable spar secured to both the front and rear cases, acting as a hinge.

7. The headset of claim 1, wherein the speaker comprises an earbud positioned to extend into the user's ear canal.

8. The headset of claim 1, wherein the front case includes decorative earring elements on an outer side opposite the user's ear.

9. An audio headset for connection to and suspension from a human ear, comprising:
a speaker for engagement with the pinna of the ear,
a two-part housing including a front case and a rear case connected by a hinge so as to swing toward and away from one another, and including a spring urging the two cases toward one another,
an adjustable speaker boom connecting the speaker with the housing, and the housing including electronics connected by conductors to the speaker along the boom,
the housing further including a transceiver, an antenna, and a microphone connected to the electronics, the microphone being oriented toward a user's mouth,
a set of clamp pads on the two casings, positioned to be at opposite sides of the lobe of a user's ear, so that the clamp pads engage the ear lobe and secure the housing to the ear lobe under the influence of the spring when the housing is positioned with the casings on opposite sides of the ear lobe.

10. The headset of claim 9, wherein the housing includes a battery wired to the electronics, with the battery and electronics being contained in different ones of the two cases.

11. The headset of claim 9, wherein the speaker boom comprises a bendable electrical cord with the conductors connecting the speaker to the electronics.

12. The headset of claim 9, wherein the electronics are contained in the housing case from which the boom extends.

13. The headset of claim 9, wherein the hinge comprises a bendable spar secured to both the front and rear cases, acting as a hinge.

14. The headset of claim 9, wherein the speaker comprises an earbud positioned to extend into the user's ear canal.

15. The headset of claim 9, wherein the front case includes decorative earring elements on an outer side opposite the user's ear.

16. A wireless audio headset for action to and suspension from a human ear, comprising:
an earbud for engagement with the pinna of the ear, in or adjacent to a user's ear canal,
a housing with electronics and including a transceiver, an antenna connected to the electronics, and a microphone connected by conductors to the electronics in the housing and oriented toward a user's mouth when the headset is worn,
a speaker on the housing,
an boom comprising a sound tube connecting the earbud to the housing, and the housing to receive sound from the speaker and transfer the sound to the earbud, and
the housing further including a transceiver, an antenna, and
ear lobe attachment means for securing the housing to a user's ear lobe.

17. A wireless audio headset for action to and suspension from a human ear, comprising:
a speaker for engagement with the pinna of the ear,
a two-part housing including a front case and a rear case connected by a hinge so as to swing toward and away from one another, one of the cases having an ear pierce post extending generally toward the other case, and including a spring urging the two cases toward one another,
an adjustable speaker boom connecting the speaker with the housing, and the housing including electronics connected by conductors to the speaker along the boom,
the housing further including a transceiver, an antenna, and a microphone connected to the electronics, the microphone being oriented toward a user's mouth when the headset is worn,
the ear pierce post being positioned to be at the lobe of a user's ear, so that the ear pierce post secures the housing to the ear lobe when the pierce post extends through a piercing in the ear lobe and with the two cases being positioned on opposite sides of the ear lobe.

18. The headset of claim 17, wherein the front case includes variable light emitting elements.
